(19) United States
(12) Patent Application Publication
(10) Pub. No.: US 2002/0002689 A1
(43) Pub. Date: Jan. 3, 2002

(54) Converting circuit for providing operating points in a central processor unit

(76) Inventor: Shih-Ping Yeh, Taipei (TW)

Correspondence Address: RABIN & CHAMPAGNE, P.C., Suite 500, 1101 14th Street, N.W., Washington, DC, 20005, US

(21) Appl. No.: 09/853,616

(22) Filed: May 14, 2001

(30) Foreign Application Priority Data
May 17, 2000 (TW) 89208316

(51) Int. Cl. G06F 1/26; G06F 1/32

(52) U.S. Cl. 713/320

(57) ABSTRACT

A converting circuit for providing operating points in a central processor unit (CPU) applying suitable resistor-capacitor (RC) circuits in the computer system. The resistance and capacitance in the RC circuits are designed to generate the needed operating frequency and voltage in the CPU. The conversion of the operating frequency and voltage is designed to be steady and synchronous so that the surge current occurring in the prior art can be reduced, thereby lowering cost.

### BACKGROUND OF THE INVENTION

This application incorporates by reference Taiwanese application Serial No. 089208316, Filed May 17, 2000.

### Field of the Invention

The invention relates in general to a converting circuit for providing operating points in a central processor unit (CPU), and more particularly to a converting circuit that converts the operating frequency and voltage of the central processor unit steadily and synchronously.

### Description of the Related Art

In addition to the importance of speed in processing and transferring data, minimization of power consumption is also a major consideration in modem computers. As a result, computers nowadays include special function for the conservation of power. This usually places the computer in an idle mode when, after a predetermined period of time, the computer cannot detect any information or there is no accessing of its hard disk. In the idle mode, power consumption by the computer is kept at the bare minimum. It is then returned to the active mode when a key on the keyboard is pressed or a movement in the mouse is detected.

As mentioned above, when the computer is in the idle mode, power consumption is minimized because the operating frequency and voltage of the CPU are lowered as compared to those in the normal active mode. This can result in significant savings for the user.

As FIG. 1 is depicted, the computer system 100 uses a clock generator 110 to produce a clock signal V_{B} with the frequency 14.318 MHz by the way of crystal oscillation. The frequency of the clock signal V_{B} is further increased by n times via a frequency multiplier 120 utilizes a phase lock loop 121 for locking the phase of the clock signal V_{B} and produces a frequency multiple signal V_{D}. Finally, a frequency divider 130 reduces the frequency of the signal V_{D} by m times and generates an output signal V_{F} to provide the needed operating frequency f for the central processor unit 140.

On the other hand, the computer system 100 uses a DC-to-DC voltage adjuster 150 to adjust the operating voltage V. The voltage adjuster 150 includes a first input terminal P1 for inputting a direct voltage bias V_{S} (a voltage 5V), and a second input terminal P2 for inputting a control signal CTL. When the control signal CTL is changed from the level 0 to 1, the voltage of the output signal V_{P} is increased from a low voltage L to a high voltage H in order to provide the needed operating voltage V of the CPU 140.

As depicted in FIG. 2A, when the computer system 100 is in the idle mode D, the operating frequency f of the CPU 140 is set to be 100 MHz and the operating voltage V is 1.3V. When the computer system 100 is changed to the active mode W at time t₀, the operating frequency f is changed to 800 MHz while the operating voltage V is increased to 1.8V. However, at time t₀, the electric current I of the computer system 100 is also increased suddenly from a low current 1A to a high current 1OA. This abrupt increase in current will result in a surge current as illustrated in FIG. 2B. As a result, extra protectors are needed to avoid this surge current, thereby increasing the cost.

### SUMMARY OF THE INVENTION

It is therefore an object of the invention to provide an improved converting circuit for converting the operating points of the CPU. By installing suitable resistor-and-capacitor (RC) circuits in the computer system, the operating frequency and voltage of the CPU can be converted steadily by adjusting the values of the resistor (R) and the capacitor (C). The variation of the operating frequency and voltage is also designed to be synchronous so that the surge current mentioned above can be reduced, thereby lowering the cost.

The invention achieves the above-identified objects by providing a new converting circuit for converting the operating points of the CPU. The converting circuit includes a phase lock loop and a voltage adjuster. The converting circuit is for receiving a clock signal, a direct voltage bias, and a control signal CTL, and outputting an operating frequency and voltage to the CPU. In the phase lock loop, a first RC circuit is used to receive the clock signal and outputs to a voltage controlling oscillator which outputs the operating frequency to the CPU. The voltage adjuster receives the direct voltage bias via its voltage amplifier and receives the control signal by a second RC circuit. As a result of this, the voltage amplifier outputs the operating voltage to the CPU. By utilizing suitable RC values in the first and second RC circuits, the surge current in the operating points conversion can be reduced, thereby lowering the cost.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 (Prior Art) illustrates a block diagram of the operating frequency and voltage conversion in a conventional computer system;

FIG. 2A (Prior Art) contains figures respectively show the change of the frequency and voltage along with time;

FIG. 2B (Prior Art) shows the change of current along with time;

FIG. 3 shows a converting circuit diagram of the operating frequency and voltage in a CPU according to a preferred embodiment in the invention; and

FIG. 4 shows a differential curve of the operating frequency and voltage according to the invention.

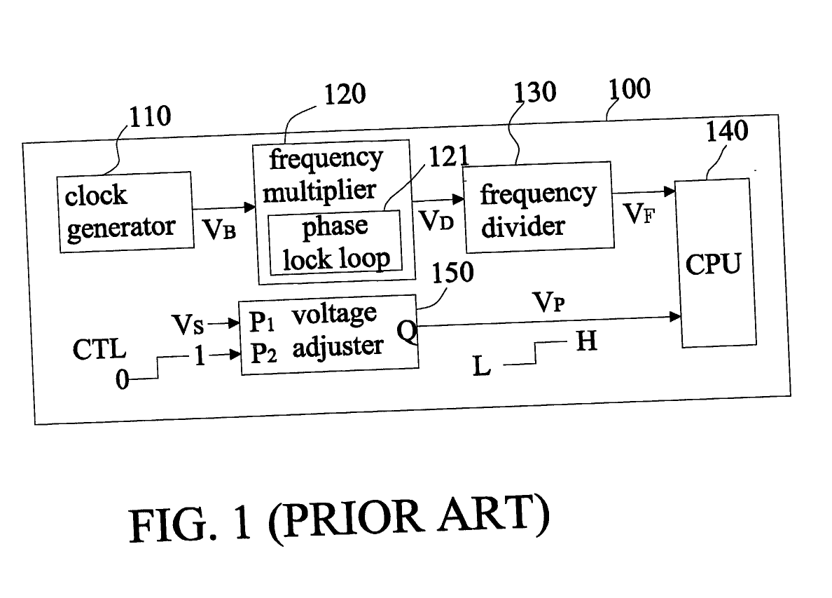

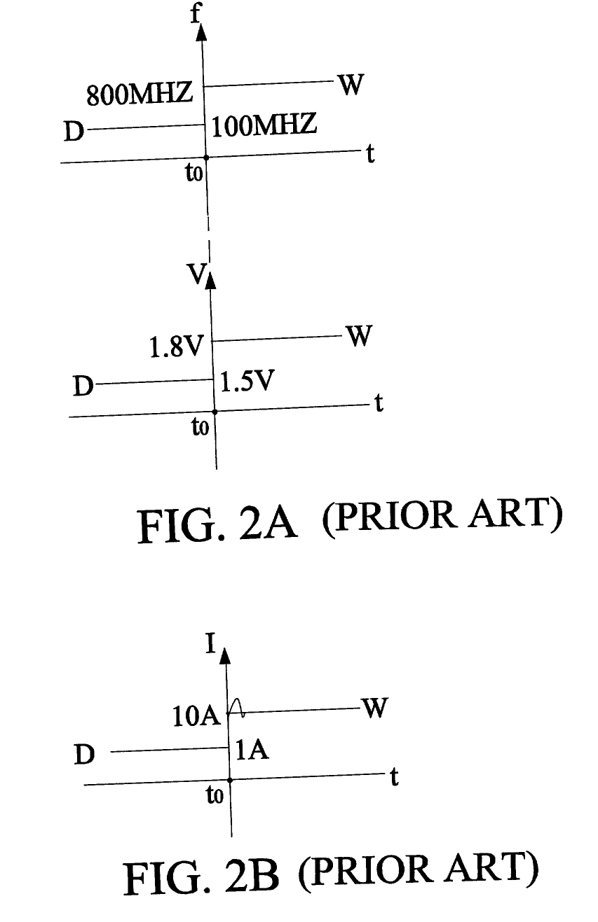

### DESCRIPTION OF THE PREFERRED EMBODIMENT

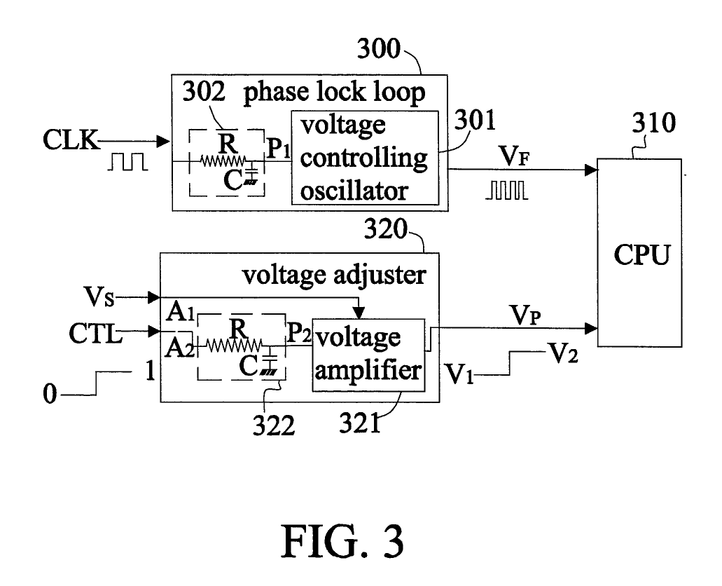

As shown in Figure. 3, the converting circuit includes a phase lock loop 300 for receiving a clock signal CLK and generating an output signal V_{F} to provide the needed operating frequency f in a CPU 310. The converting circuit also includes a voltage adjuster 320 for receiving a control signal CTL (0/1 level) to provide the needed operating voltage V_{P} in the CPU 310.

The phase lock loop 300 includes a voltage controlling oscillator 301 and a first RC circuit 302 which connects to a first input terminal P1 of the voltage controlling oscillator 301. The voltage adjuster 320 includes a bias input terminal A1 for inputting a direct voltage bias V_{S} (e.g. 5V), and a signal input terminal A2 for receiving the control signal CTL. The voltage adjuster 320 further includes a voltage amplifier 321 and a second RC circuit 322. The second RC circuit 322 connects the voltage amplifier 321 to the signal input terminal A2 for receiving the control signal CTL and outputs the result to the voltage amplifier 321 via a second input terminal P2. The voltage amplifier 321 receives the direct voltage bias V_{S} and generates an output signal V_{P} with the voltage V under the control of the control signal CTL.

As mentioned above, the first RC circuit 302 and the second RC circuit 322 can be composed of a resistor R and a capacitor C. For example, the resistance of the resistor R can be hundreds of kΩ and the capacitance of the capacitor C can be varied from tens μF to hundreds μF. The invention applies the characteristic time delay resulting from the RC circuits to steadily provide the needed operating frequency and voltage in the CPU so that the surge current of the operating point variation can be avoided. In addition, the resistors R and the capacitors C in the first and the second RC circuits can be further designed so that the variations in operating frequency and voltage are synchronous in order to match the requirement of the CPU.

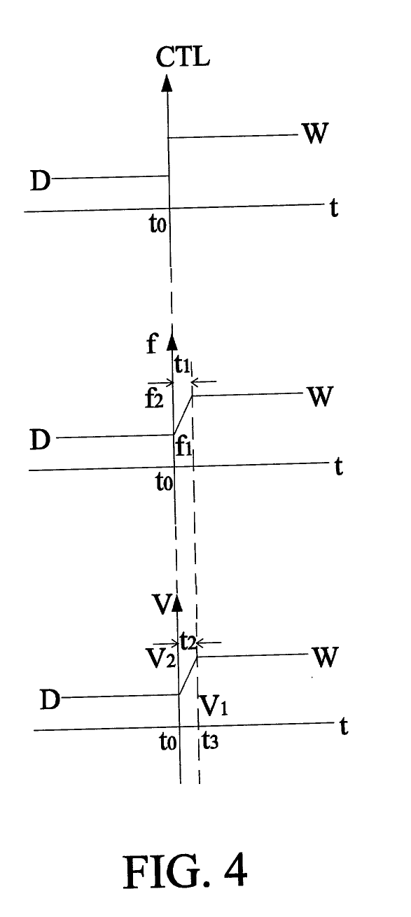

As depicted in Figure. 4, when the CPU 310 is changed from the idle mode D to the active mode W at time t₀, the operating frequency f is increased from low value f1 to high value f2, while the operating voltage V is increased from low value V1 to high value V2. Because of the first RC circuit 302 and the second RC circuit 322, the operating frequency f and voltage V are increased steadily at the time t₀. Moreover, the operating frequency f and voltage V are designed to be synchronous, that is, the delay time t₁ of the operating frequency f and the delay time t₂ of the operating voltage V are the same so that the computer system can be converted from the idle mode to the active mode synchronously and steadily.

The characteristic of the invention lies in that the first and second RC circuits are installed into the phase lock loop and the voltage adjuster respectively. The produced RC of the first and second RC circuits are designed to provide the steady conversion of the operating frequency f and voltage V between time t₀ and t₃. According to the allowance of the CPU for the steady conversion of the operating points, the invention reduces the surge current of the operating points in the prior art and provides high system stability without lowering its efficiency.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A converting circuit for providing operating points in a central processor unit (CPU), for receiving a clock signal, a direct voltage bias, and a control signal, and outputting an operating frequency and an operating voltage to the CPU, the converting circuit comprising:
a phase lock loop, including a first resistor-capacitor (RC) circuit and a voltage controlling oscillator, the phase lock loop receiving the clock signal from the first RC circuit and outputting the result to the voltage controlling oscillation, the voltage controlling oscillation outputting the operating frequency to the CPU; and
a voltage adjuster, comprising:
a voltage amplifier for receiving the direct voltage bias, and
a second RC circuit for receiving the control signal and outputting the result to the voltage amplifier for controlling the voltage amplifier to output the operating voltage to the CPU.

2. A converting circuit according to claim 1, wherein the operating frequency is changed from a lower value to a higher value with a first delay time as the CPU is changed from an idle mode to an active mode.

3. A converting circuit according to claim 2, wherein the operating voltage is changed from a lower value to a higher value with a second delay time.

4. A converting circuit according to claim 3, wherein the first delay time is the same with the second one.

5. A converting circuit according to claim 1, wherein the direct voltage bias is 5V.

6. A converting circuit according to claim 1, wherein the first RC circuit at least comprises a resistor and a capacitor.

7. A converting circuit according to claim 1, wherein the second RC circuit at least comprises a resistor and a capacitor.

8. A converting circuit for providing operating points, comprising:
a phase lock loop, comprising a first RC circuit and a voltage controlling oscillator, the phase lock loop receiving a clock signal from the first RC circuit and outputting the result to the voltage controlling oscillation, the voltage controlling oscillation outputting an operating frequency; and
a voltage adjuster, comprising:
a voltage amplifier for receiving a direct voltage bias, and
a second RC circuit for receiving a control signal and outputting the result to the voltage amplifier for controlling the voltage amplifier to output an operating voltage.
